(19) United States
(12) Patent Application Publication
(10) Pub. No.: US 2026/0324877 A1
(43) Pub. Date: Oct. 22, 2026

(54) CLIP FOR CUSHION

(71) Applicant: LEAR CORPORATION, Southfield, MI (US)

(72) Inventors: Joshua HALLOCK, Warren, MI (US); Samuel BLAIR, Troy, MI (US); Lisa SWIKOSKI, West Bloomfield, MI (US); David ABDELLA, Royal Oak, MI (US)

(21) Appl. No.: 19/637,502

(22) Filed: Apr. 2, 2026

Related U.S. Application Data
(63) Continuation of application No. 18/866,444, filed on Jun. 22, 2023, now abandoned.
(60) Provisional application No. 63/356,192, filed on Jun. 28, 2022.

(30) Foreign Application Priority Data
Jan. 19, 2023 (DK) PA202370025

(51) Int. Cl. A47C 31/02; F16B 2/20

(52) U.S. Cl. CPC A47C 31/023; F16B 2/20

(57) ABSTRACT

A clip for a cushion includes an attachment body defining an attachment surface, and a lead member for engaging a cushion including a stranded-mesh material. The lead member may have a curved profile for retaining the clip in the cushion, or include protrusions for engaging the polymer strands of the stranded-mesh material. The attachment surface includes an attachment feature thereon such that components and/or features (such as trim covers or comfort components) may be secured to the cushion via the clip. Thus, a seat assembly includes a cushion having a body of the stranded-mesh material, a feature or component to be connected with the cushion, and a clip engageable with the cushion having the attachment body and lead member, with the component or feature being attachable to the attachment body at the attachment surface.

### CROSS-REFERENCE TO RELATED APPLICATIONS

This application is a continuation of and claims priority to U.S. Patent Application Serial No. 18/866,444, filed on Nov. 15, 2024, which is a National Stage Entry of PCT Application No. PCT/US2023/025976, filed on Jun. 22, 2023, which claims the benefit of U.S. Provisional Patent Application Serial No. 63/356,192, filed on Jun. 28, 2022, and Danish Patent Application No. PA202370025, filed on Jan. 19, 2023, the disclosures of which are hereby incorporated in their entireties by reference herein.

### TECHNICAL FIELD

The present application is directed to a clip, and more particularly, a clip for attaching features to a cushion.

### BRIEF DESCRIPTION OF THE DRAWINGS

FIG. 1 is a perspective view of a clip, according to an embodiment;

FIG. 2 is a side view of the clip of FIG. 1;

FIG. 3 is a perspective view of a clip, according to another embodiment;

FIG. 4 is a side view of the clip of FIG. 3; and

FIG. 5 is a schematic illustration of a clip engaged with a cushion, according to an embodiment;

### DETAILED DESCRIPTION

Reference will now be made in detail to embodiments, examples of which are illustrated m the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, and components have not been described in detail so as not to unnecessarily obscure aspects of the embodiments.

It is to be understood that the disclosed embodiments are merely exemplary and that various and alternative forms are possible. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ embodiments according to the disclosure.

"One or more" includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the v�1rious described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms "a", "an" and "the" are intended to include the plural forms as well, unless the context clearly indicates otherwise. It will also be understood that the term "and/or" as used herein refers to and encompasses any and all possible combinations of one or more of the associated listed items. It will be further understood that the terms "includes," "including," "comprises," and/or "comprising," when used in this specification, specify the presence of stated features. integers, steps, operations, elements, and/or components, but do not preclude the presence or addition of one or more other features, integers, steps, operations, elements, components, and/or groups thereof.

Moreover, except where otherwise expressly indicated, all numerical quantities in this description and in the claims are to be understood as modified by the word "about" in describing the broader scope of this invention. The term "substantially," "generally," or "about" may be used herein and may modify a value or relative characteristic disclosed or claimed. In such instances, "substantially," "generally," or "about" may signify that the value or relative characteristic it modifies is within± 0%, 0.1%, 0.5%, 1%, 2%, 3%, 4%, 5% or 10% of the value or relative characteristic. Practice within the numerical limits stated is generally preferred. Also, unless expressly stated to the contrary, the description of a group or class of materials by suitable or preferred for a given purpose in connection with the invention implies that mixtures of any two or more members of the group or class may be equally suitable or preferred.

According to one or more embodiments, a clip for a cushion is provided. The clip includes an attachment body (or, hereinafter interchangeably, body) defining an attachment surface on a first side of the body, and a lead member having a first end connected to the body on a second side of the body, and the lead member having a second end opposite to the first end. The second end is spaced from the second side of the body (i.e., not connected to the body), to form a space between the body and the lead member, with an opening defined at the second end between the lead member and the body such that the opening allows the lead member to be engageable with a cushion. In certain embodiments, the second end is sized and/or shaped to facilitate the engagement with a skin of the cushion or strands of a foamless cushion. In certain further embodiments, where the cushion is a foamless cushion comprising a network of strands, the skin of the foamless cushion is a denser network of strands relative to a foamless cushion body, and the second end engages one or both of the skin and denser network. The lead member is engageable with the cushion such that features on the attachment surface of the body can be secured to the cushion via the clip. Details of the clip and the attachment of features to the cushion via the clip with will be discussed with reference to the Figures.

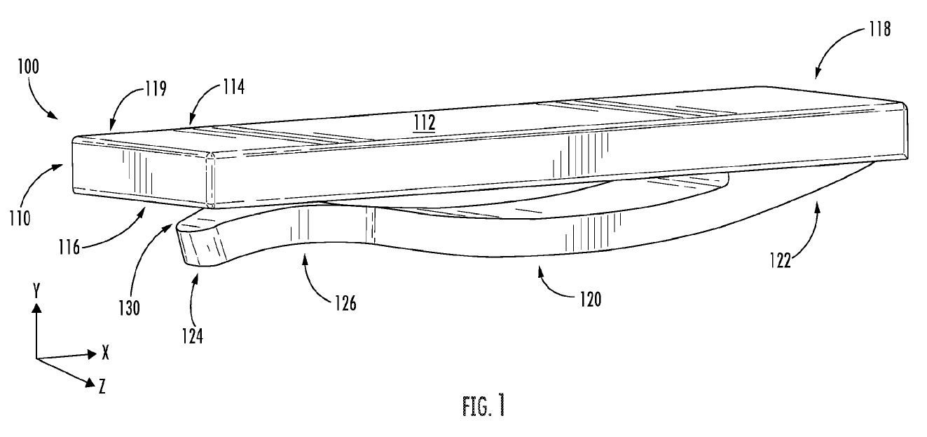

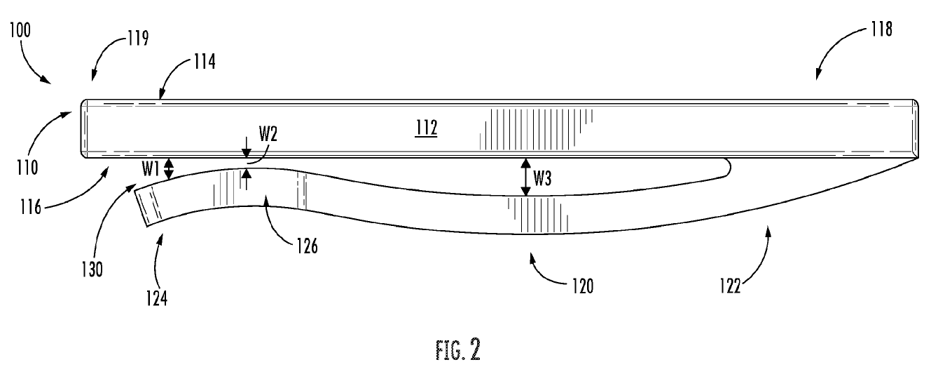

Referring to FIGS. 1-2, a clip 100 for a cushion is provided, according to an embodiment. The clip 100 includes an attachment body 110 defining an attachment surface 112 on a top side 114 of the attachment body 110. The attachment surface 112 supports connection elements (not shown) to connect trim or comfort systems to the cushion. For example, the attachment surface 112 may include one of a hook and loop fastener, or include other mechanical connection features (e.g., a hook, or a button component), in order to secure a component or feature (such as, but not limited to, a trim cover) to the clip 100 at the attachment surface 112. In certain examples, the attachment surface 112 may be substantially flat or, interchangeably planar. The attachment body 110 may be made of any suitable material having sufficient rigidity to secure a component or feature to the clip 100 and retain the component or feature with the cushion (not shown). The attachment body 110 may be any suitable material having sufficient rigidity to secure a component or trim cover to the cushion. Although shown as having a generally elongated rectangular shape, the attachment body 110 may have any suitable shape based on the desired attachment feature for the attachment surface 112. As such, in other embodiments (not shown), the attachment body 110 may have a square, circular, elliptical, or other polygonal shape. Although the attachment feature can be positioned on the attachment surface 112, the attachment feature may, in some embodiments, be formed integrally with the attachment body 110, and discussion of a feature supported on the attachment surface 112 is not intended to be limiting. On a bottom side 116 of the attachment body 110, opposite to the top side 114 with the attachment surface 112, the clip 100 includes a lead member 120 attached thereto on a first end 118 of the attachment body 110. The lead member 120 includes a first lead member end 122 attached to the bottom side 116 of the attachment body, and a second lead member end 124 opposite to the first lead member end 122. The second lead member end 124 of the lead member 120 is freestanding below the bottom side 116 of the attachment body 110 corresponding to the second end 119 of the attachment body 110 (opposite to the first end 118). The lead member 120 is not attached to the attachment body 110 at the second lead member end 124, and the lead member 120 and the attachment body 110 cooperate to define an opening 130 therebetween with a width in the Y-axis, which receives a portion of the cushion therein in order to secure the clip 100 to the cushion and allow attachment of features and/or components at the attachment surface 112 to the clip 100.

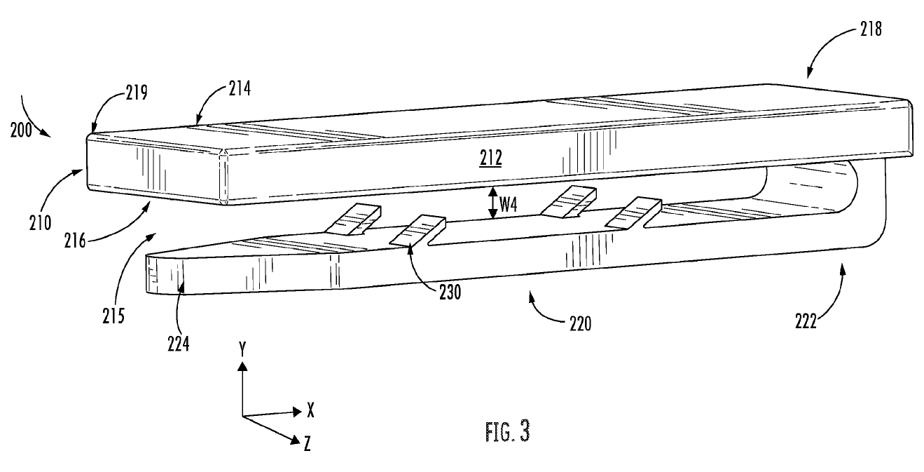

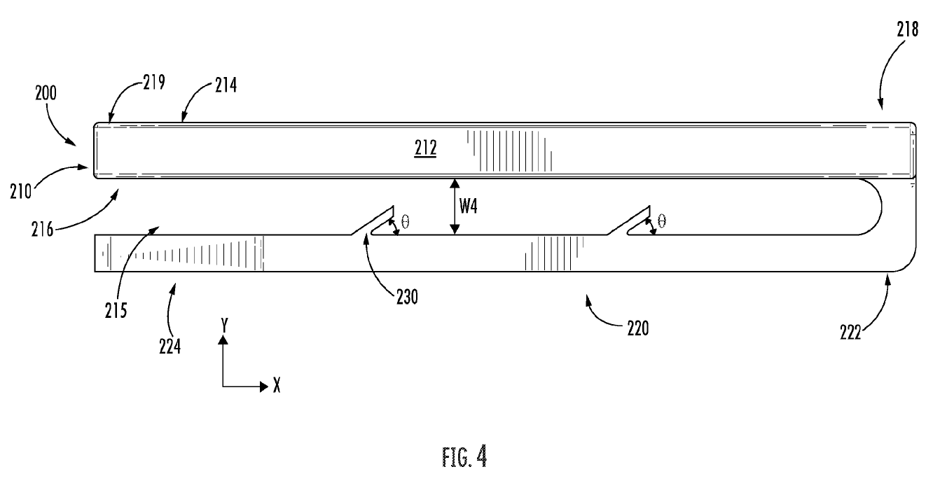

The lead member 120 facilitates engagement with a cushion (not shown), as the lead member 120 is inserted through a skin of the cushion and is engageable with the cushion body. As shown in the embodiment of FIGS. 1-2, the lead member 120 has a generally curved profile between the first lead member end 122 and the second lead member end 124. As such, the opening 130 has a varying width defined along the X-axis, as shown in FIG. 2. For example, the opening 130 has a width Wl towards the second lead member end 124, which gradually decreases to width W2, forming a pinch point 126, before widening to width W3. The width then lessens towards the first lead member end 122. Although shown as having one pinch point 126 and two inflection points in the curve, the lead member 120 may have any number of curves and injection points in the curve to form any suitable number of pinch points 126 formed by the inflection points as based on the size of the clip 100 or the retention force desired for the clip 100. The pinch point 126 facilitates engagement of the cushion (not shown) within the opening 130. In another embodiment, as will be discussed with reference to FIGS. 3-4, the lead member 120 may also have a flat profile. Furthermore, in the embodiment of FIGS. 1-2, the width Wl is wider than the width W2 at the pinch point 126, which to facilitate the insertion of the clip 100 via the second lead member end 124, such that the cushion can be fed into the opening 130. In certain examples, the pinch point 126 may have a width W2 between the bottom surface 116 of the attachment body 110 and the lead member 120 of 0.1 to 25 mm, 0.25 to 20 mm in other embodiments, and 0.5 to 15 mm in yet other embodiments. In at least one embodiment, as shown in FIGS. 1-2, the lead member 120 may include a narrow tip at the second lead member end 124 to facilitate insertion into the cushion. Although shown as having a triangular tip, other shapes of the tip are contemplated, and depiction of a triangular tip is not intended to be limiting. As such, the clip 100 provides a low profile attachment method for features and components to the cushion.

Referring to FIGS. 3-4, a clip 200 for a cushion is provided, according to another embodiment. The clip 200 includes an attachment body 210 defining an attachment surface 212 on a top side 214 of the attachment body 210. The attachment surface 212 supports connection elements (not shown) to connect trim or comfort systems to the cushion. For example, the attachment surface 212 may include one of a hook and loop fastener, or include other mechanical connection features (e.g., a hook, or a button component), in order to secure a component or feature (such as, but not limited to, a trim cover) to the clip 200 at the attachment surface 212.

The attachment body 210 may be made of any suitable material, as discussed previously with reference to the embodiment of FIGS. 1-2. Although shown as having a generally elongated rectangular shape, the attachment body 210 may have any suitable shape based on the desired attachment feature for the attachment surface 212. As such, in other embodiments (not shown), the attachment body 210 may have a square, circular, elliptical, or other polygonal shape. Although the attachment feature can be positioned on the attachment surface 212, the attachment feature may, in some embodiments, be formed integrally with the attachment body 210, and discussion of a feature supported on the attachment surface 212 is not intended to be limiting. Similarly, the attachment surface 212 may be substantially flat, or interchangeably, substantially planar. On a bottom side 216 of the attachment body 210, opposite to the top side 214 with the attachment surface 212, the clip 200 includes a lead member 220 attached thereto on a first end 218 of the attachment body 210. The lead member 220 includes a first lead member end 222 attached to the bottom side 216 of the attachment body on the first end 218, and a second lead member end 224 opposite to the first lead member end 222. The second lead member end 224 of the lead member 220 is freestanding below the bottom side 216 of the attachment body 210 corresponding to a second end 219 of the attachment body 210 (opposite to the first end 218). The lead member 220 is not attached to the attachment body 210 at the second lead member end 224. The lead member 220 and the attachment body 210 cooperate to define an opening 215 therebetween with a width in the Y-axis, which receives a portion of the cushion therein to secure the clip 200 to the cushion in order to allow attachment of features and/or components at the attachment surface 212 to the clip 200.

The lead member 220 facilitates engagement with a cushion (not shown), as the lead member 220 is inserted through a skin of the cushion and is engageable with the cushion body. As shown in the embodiment of FIGS. 3-4, the lead member 220 has a generally straight profile between the first lead member end 222 and the second lead member end 224. As such, the opening 215 has a generally constant width W4 defined along the X-axis, as shown in FIG. 4. In certain examples, the width W4 may be 1 to 150 mm, in other examples 2 to 100 mm, and in yet other examples, 3 to 50 mm. In the embodiment of FIGS. 3-4, the lead member 220 includes one or more protrusions 230 on an inner surface 226 of the lead member 220, facing the bottom surface 216 of the attachment body 210. The protrusions 230 are engageable with the cushion to further retain the clip 200 on the cushion, and subsequently support the trim or comfort system component attached thereon at the attachment surface 212. Although four protrusions 230 are shown on the lead member 220 of FIGS. 3-4, this is not intended to be limiting, and any suitable number of protrusions 230 at any suitable location on the lead member 220 is contemplated. For example, there may be additional protrusions 230 or additional rows of protrusions 230, especially in embodiments where the clip 200, and thus lead member 220, are larger. Additionally, although shown as separate protrusions 230 on the Z-axis, each row of protrusions 230 (along the X-axis) may be a singular protrusion 230 spanning the depth of the lead member 220 (along the Z-axis). Moreover, the protrusions 230 extend from the inner surface 226 toward the bottom surface 216 at an angle 0 towards the second end 219 of the attachment body 210 such that the protrusions 230 facilitate retention of the cushion in the opening 215. The angle 0 may be any suitable angle for retaining the cushion within the opening, such as, but not limited to, 10 to 90 degrees. Although the shape of the protrusions 230 is shown generally as a rectangular protrusion, any suitable shape is contemplated to engage the cushion, including, but not limited to, triangular prongs, rounded prongs, or other polygonal shapes. In at least one embodiment, as shown in FIGS. 3-4, the lead member 220 may include a narrow tip at the second lead member end 224 to facilitate insertion into the cushion. Although shown as having a triangular tip, other shapes of the tip are contemplated, and depiction of a triangular tip is not intended to be limiting. As such, the clip 200 provides a low profile attachment method for features and components to the cushion.

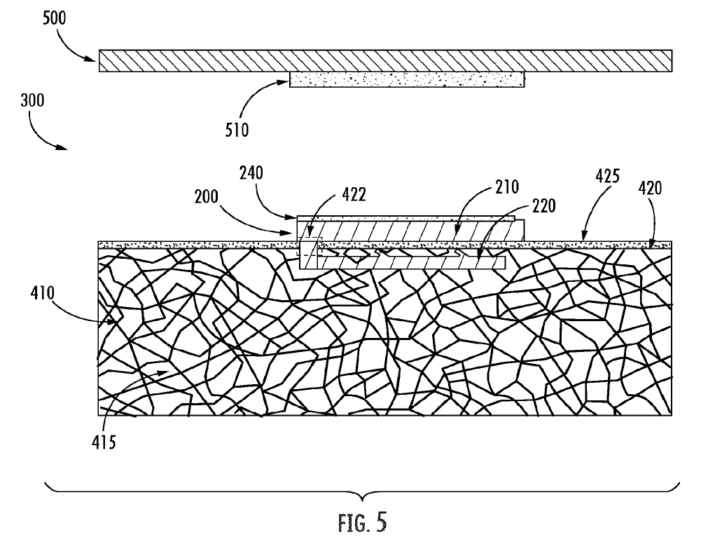

Referring to FIG. 5, a seat assembly 300 is shown including the clip 200 of FIGS. 3-4. Although the clip 200 is shown, a similar configuration is contemplated for the clip 100 of FIGS. 1-2, and the depiction of the clip 200 in a seat assembly 300 is not intended to be limiting. The seat assembly 300 includes a cushion 400 and a trim cover 500, with the trim cover 500 being securable to the cushion 400 via the clip 200. Although a trim cover 500 is described, this is an example of a feature or component that can be secured to the cushion 400 via the clip 200, and is not intended to be limiting. Other features and/or components such as comfort systems, wiring, electronics, and the like, are also contemplated. As previously discussed, and as shown in FIG. 5, the cushion 400 is a foamless cushion made from a stranded-mesh material 410 with a skin 420, with the skin 420 defining an outer surface 425 of the cushion 400. The stranded-mesh material 410 is made from a polymeric mesh having a plurality of integrated polymeric strands 415. For clarity, only some of the strands 415 are labeled. The stranded-mesh material 410 may be, for example, a linear low density polyethylene material, although other polymers and materials effective to provide the desired properties and functionality are contemplated. The stranded-mesh material 410 has a surface 412 with the skin 420 thereon. The skin 420 may be a denser network of the polymeric strands 415 relative to the stranded-mesh material 410, or be a polymeric layer forming the skin 420. In certain embodiments, as shown in FIG. 5, the skin 420 may define a skin opening 422 therein for receiving the clip 200 therethrough such that the clip 200 provides the attachment surface 212 to secure the trim cover 500 thereto. In embodiments where the skin 420 is a polymeric layer (not shown), the skin 420 may define small or microscopic pores to provide access for the lead member 220 of the clip 200 through the skin. One method for producing the skin 420 on the stranded-mesh material 410 is to apply heat and force until at least some of the polymeric strands melt into each other to form the skin 420.

As shown in FIG. 5, the lead member 220 of the clip 200 is fed through the skin opening 422 and into the stranded-mesh material 410, while the attachment body 210 rests with the bottom surface 216 adjacent to the outer surface 425 of the cushion. At least the skin 420 is thus supported in the opening 215 defined between the attachment body 210 and the lead member 220, and in some embodiments, as shown in FIG. 5, a portion of the stranded-mesh material 410 is also supported in the opening 215. In the embodiment shown in FIG. 5, the protrusions 230 on the inner surface 226 of the clip 200 engage the polymeric strands 415 of the cushion to retain the clip 200 on the cushion 400. In an embodiment including a clip 100 from FIGS. 1-2 (not shown), the curved profile of the lead member 120 is guided through the skin opening 422 to hook onto the polymeric strands 415, with the pinch point 126 inhibiting disengagement of the clip 100 with the polymeric strands 415.

Referring again to FIG. 5, the clip 200 includes an attachment feature 240 (shown schematically, for example, as a component of a hook and loop fastener) on the attachment surface 212 of the clip 200. The attachment feature 240 engages a corresponding attachment feature 510 (shown schematically, for example, as the other component of the hook and loop fastener) on the trim cover 500. The attachment feature 510 may be attached to the component (e.g., trim cover), by any suitable method, including, but not limited to, sewing, adhesives, or other mechanical fastener. Although the attachment feature 240 is shown positioned on the attachment surface 212, the attachment feature 240 may, in some embodiments, be formed integrally with the attachment body 210, and depiction of a feature supported on the attachment surface 212 is not intended to be limiting. In other embodiments, the attachment feature 240 may be secured to the attachment surface 212 via an adhesive (e.g., double sided tape) As such, a feature and/or component, such as a trim cover 500, can be secured to a cushion 400 formed from a stranded mesh material 410 using a clip 200.

According to one or more embodiments, a method of securing components to a cushion is provided. The method includes providing a cushion including a stranded-mesh material, providing a clip having an attachment body with a top attachment surface and a bottom surface and a lead member secured on the bottom surface, the lead member having a first end attached to the bottom surface, and a second end, opposite to the first end, being a freestanding end positioned below the attachment body. The method includes inserting the lead member in the stranded-mesh material. In certain further embodiments, the inserting includes engaging protrusions on the lead member with polymer strands of the stranded-mesh material. The method further includes securing a component to the top attachment surface via an attachment feature on the top attachment surface, and a corresponding attachment feature on the component.

According to one or more embodiments, a clip for a cushion is provided. The clip is engageable with a stranded-mesh material of the cushion, and provides an attachment surface for receiving an attachment feature thereon such that components and/or features (such as trim covers or comfort components) may be secured to the cushion. The clip includes an attachment body defining the attachment surface, and includes a lead member for engaging with the stranded-mesh material. The lead member may have a curved profile for retaining the clip in the cushion, or include protrusions for engaging the polymer strands of the stranded-mesh material. A seat assembly thus includes the cushion having a body of the stranded-mesh material, a feature or component to be connected with the cushion, and a clip engageable with the cushion having the attachment feature to retain the feature or component thereon.

While exemplary embodiments are described above, it is not intended that these embodiments describe all possible forms according to the disclosure. In that regard, the words used in the specification are words of description rather than limitation, and it is understood that various changes may be made without departing from the spirit and scope of the disclosure. Additionally, the features of various implementing embodiments may be combined to form further embodiments according to the disclosure.

1. A clip for a cushion comprising:an attachment body defining a top attachment surface and a bottom surface, opposite to the top attachment surface; anda lead member having a first lead member end connected to a first end of the attachment body, and a second lead member end freestanding and positioned below a second end of the attachment body, opposite to the first end, such that the attachment body and the lead member define an opening therebetween.

2. The clip of claim 1, wherein the lead member includes one or more protrusions on an inner surface of the lead member, the inner surface facing the bottom surface of the attachment body.

3. The clip of claim 2, wherein the one or more protrusions extend from the inner surface and are angled toward the first end of the attachment body.

4. The clip of claim 1, wherein the lead member has a curved profile having one or more pinch points for facilitating retention of the clip with the cushion wherein the one or more pinch points are formed by inflection points in the curved profile.

5. (canceled)

6. The clip of claim 4, wherein the curved profile defines a varying width of the opening along a length of the lead member.

7. The clip of claim 1, further comprising an attachment feature on the top attachment surface to secure a component to the cushion.

8. The clip of claim 7, wherein the attachment feature is a hook fastener, loop fastener, or mechanical connector.

9. The clip of claim 1, wherein the first lead member end is connected to the bottom surface of the attachment body.

10. (canceled)

11. The clip of claim 1, wherein the lead member is engageable with a stranded-mesh material of the cushion such that a portion of the stranded- mesh material is received in the opening of the clip.

12. A seat assembly comprising:a cushion including a stranded-mesh material of polymer strands;a clip engageable with the cushion, the clip having an attachment body defining an attachment surface with an attachment feature thereon, and a lead member having a first end connected to the attachment body, and a second end freestanding and positioned below the attachment body such that the attachment body and the lead member define an opening therebetween to receive the stranded-mesh material of the cushion therein; anda component to be secured to the cushion, the component including a corresponding attachment feature to the attachment feature of the clip,wherein the lead member is engageable with the polymer strands to retain the clip on the cushion.

13. The seat assembly of claim 12, wherein the cushion includes a skin on the stranded-mesh material.

14. The seat assembly of claim 13, wherein the skin defines a skin opening for receiving the lead member therethrough such that the skin and the polymer strands are received in the opening of the clip.

15. (canceled)

16. The seat assembly of claim 12, wherein the lead member includes one or more protrusions on an inner surface of the lead member, the inner surface facing a bottom surface of the attachment body, opposite to the attachment surface.

17. The seat assembly of claim 16, wherein the one or more protrusions extend from the inner surface and are angled toward a first end of the attachment body corresponding to the first end of the lead member.

18. The seat assembly of claim 12, wherein the lead member has a curved profile having one or more pinch points for facilitating retention of the clip with the cushion.

19. The seat assembly of claim 18, wherein the one or more pinch points are formed by inflection points in the curved profile, with the inflection points define a varying width of the opening along a length of the lead member.

20. The seat assembly of claim 12, wherein the attachment surface is substantially planar.

21. A method of forming a seat assembly comprising:
engaging a clip with a stranded-mesh material of a cushion by inserting a lead member into the stranded-mesh material such that the lead member engages with polymer strands of the stranded-mesh material to retain the clip on the cushion, the clip defining an attachment surface
on an attachment body, and the lead member connected to the attachment body on a first lead member end, and having a second lead member end freestanding and positioned below the attachment body such that the attachment body and the lead member define an opening therebetween; and
positioning the attachment body adjacent to an outer surface of the cushion.

22. The method of claim 21, further comprising retaining the clip on the cushion by engaging protrusions of the lead member with the stranded-mesh material, the protrusions angled toward the first lead member end.

23. (canceled)

24. The method of claim 21, wherein the engaging includes inserting the lead member through the stranded-mesh material.

25. (canceled)

26. (canceled)
